(19) United States
(12) Patent Application Publication
(10) Pub. No.: US 2026/0257329 A1
(43) Pub. Date: Sep. 3, 2026

(54) COLD START CONTROL OF A POWER TOOL

(71) Applicant: Hilti Aktiengesellschaft, Schaan (LI)

(72) Inventors: Maryam EFTEKHARI, Untermeitingen (DE); Markus SOMMER, Westendorf (DE)

(21) Appl. No.: 19/159,630

(22) PCT Filed: Mar. 1, 2024
(86) PCT No.: PCT/EP2024/055435

§ 371 Date: Aug. 26, 2025

(30) Foreign Application Priority Data
Mar. 16, 2023 (EP) 23162416.4

(51) Int. Cl. B25D 11/12; B25D 17/26

(52) U.S. Cl. CPC B25D 11/125; B25D 17/26; B25D 2250/095; B25D 2250/201; B25D 2250/221

(57) ABSTRACT

A method and a corresponding drive arrangement for a cold start drive control of a speed-controlled electric motor drive unit (5) for driving a power tool, especially a rotary hammer or a demolition hammer, including the following steps: switching on (I) the electric motor drive unit (5) by manually operating an electrical switch (10); detecting (II) the initial temperature (Tᵢ) inside a power tool housing (1) by at least one temperature sensor (102); comparing (III) the detected initial temperature (Tᵢ) with a stored temperature limit value (T_{L}) by an electronic control unit (101); cold controlling (IV) the electric motor drive unit (5) on a minimum desired speed (v₁) if the initial temperature (Tᵢ) is below the temperature limit value (T_{L}); nominal controlling (V) the electric motor drive unit (5) on a higher desired speed (v₂) if the initial temperature (Tᵢ) exceeds the temperature limit value (T_{L}).

The present invention relates to a method for a cold start drive control of a speed-controlled electric motor drive unit for driving a power tool, especially a rotary hammer or a demolition hammer. Furthermore, the invention relates to a drive arrangement for such a cold start drive control for carrying out this method and to an electric power tool as such. In addition, the invention also relates to a computer program or a computer program product carrying out the said method.

The field of application of the invention extends primarily to hand-held power tools, such as in particular to a rotary hammer, a demolition hammer, but also to e.g. an electric screwdriver and other power tools. The electrical power supply can be cordless via an accumulator or corded in a conventional manner.

The hammering mechanism of hand-held electric power tools of the type of interest here heats up during operation due to friction of moving components and thermal losses in the air spring. An operating temperature between 80° C. and 150° C. typically results. Lubricants, seals, dimensions, and tolerances of the hammering mechanism are designed with regard to the typical operating temperature. However, at the beginning of being put into operation, the hammering mechanism is cold, in particular in cold work environments below the freezing point. The conditions are not optimal for the hammering mechanism and may prevent reliable starting of the hammering mechanism.

Furthermore, after a long standstill at low temperature, the lubricant may harden, causing the mechanism to malfunction. Usually, it takes a long time to warm up the power tool.

### BACKGROUND OF THE INVENTION

The document US 2019/0314970 A1 discloses a method for overcoming this cold lubrication problem by applying a predefined ramp in the speed instead of jumping to the nominal speed right after switching on the power tool. Therefore, the known method includes the steps of detecting a temperature using a temperature sensor, activating an pneumatic hammering mechanism in response to an actuation of the electrical tool switch. If the temperature is higher than a limiting temperature, the repetition rate is continuously increased from idle up to a set point value. The duration until reaching the set point value is less than 10 cycles. If the temperature is less than the limiting temperature, a duration until reaching the set point value is greater than 200 cycles.

### SUMMARY OF THE INVENTION

Although, applying a speed ramp in the motor control can help reducing the activation time of mechanical components in a power tool, however, after detecting the cold state, the desired motor speed will be independent of the real status of the mechanical parts, especially a hammering mechanism, and still the warmup time can take longer than needed.

It is an object of the present invention to provide a warmup method and arrangement for a cold start of a speed-controlled electric motor drive unit for driving a power tool, which ensures a fast warmup time for speeding up the activation of the power tool in order to bring maximum power to the user as soon as possible under cold environmental conditions.

The present invention provides a method for a cold start drive control of a speed-controlled electric motor drive unit (5) for driving a power tool, especially a rotary hammer or a demolition hammer, comprising the following steps:
switching on (I) the electric motor drive unit (5) by manually operating an electrical switch (10);
detecting (II) the initial temperature (Tᵢ) inside a power tool housing (1) by at least one temperature sensor (102);
comparing (III) the detected initial temperature (Tᵢ) with a stored temperature limit value (T_{L}) by an electronic control unit (101);
cold controlling (IV) the electric motor drive unit (5) on a minimum desired speed (v₁) if the initial temperature (Tᵢ) is below the temperature limit value (T_{L});
nominal controlling (V) the electric motor drive unit (5) on a higher desired speed (v₂; vₙ) if the initial temperature (Tᵢ) exceeds the temperature limit value (T_{L}). A speed-controlled drive arrangement suitable for carrying out the method is also provided as well as an electric power tool with such a speed-controlled drive arrangement. A computer program product for carrying out the method according to the invention is also provided, the steps of which are implemented in corresponding program code.

The present invention includes the technical teaching that after switching on the electric motor drive unit by manually operating an electrical switch, the following steps are carried out:

Detecting the initial temperature Tᵢ inside a power tool housing by at least one temperature sensor; comparing the detected initial temperature Tᵢ with a stored temperature limit value T_{L} by an electronic control unit; cold controlling the electric motor drive unit on a minimum desired speed v₁ if the initial temperature Tᵢ is below the temperature limit value T_{L}; nominal controlling the electric motor drive unit on a higher desired speed v₂ if the initial temperature Tᵢ exceeds the temperature limit value T_{L}.

With other words, the method of the present invention ensures, that after switching on the power tool, first the inside temperature Tᵢ will be read by the at least one temperature sensor. Secondly, by detecting a cold temperature, the minimum desired speed v₁ which can at least activate a hammering mechanism will be set for the speed regulator of the electronic control unit and then the desired speed will be preferably stepwise increased on a higher desired speed v₂, which is preferably the nominal speed vₙ of the power tool.

The technical solution according to the present invention does not need any specific extra hardware and a high number of calculations. The method only uses the available measurements and calculated values and decide finally about the desired speed for the cold start feature.

Preferably, the nominal speed vₙ will be executed independently on the measured initial temperature Tᵢ if a fix time limit after switching on the electric motor drive unit is expired. The fix time limit can be set in the range of 3 to 20 seconds, wherein the concrete value depends on the construction features of the mechanism. The fix time limit ensures, that the cold start feature will not stay active forever, and it will be disabled after the time limit, which means the user will have the maximum power of the tool after the defined fix time limit.

According to a preferred embodiment, in which a hammering mechanism is a part of the power tool, the temperature limit value T_{L} is set at a temperature above 0, preferably 1° C. The minimum desired speed v₂ is set to the minimum speed at which the hammering mechanism of the power tool becomes active, as already mentioned above. The higher desired speed v₂ is principally higher than the minimum desired speed v₁, preferably set at the nominal speed vₙ of the power tool.

Additionally to the cold start feature according to the present invention it is optionally recommended to monitor the reference current I_{S} of the speed-controlled electric motor drive unit calculated by the electronic control unit. In case, the reference current Is is exceeding a high current limit value I_{L}, the desired speed will be increased to the nominal speed vₙ, whereas if the reference current I_{S} is below a low current limit value I_{L}, the desired speed will be decreased for warming up the hammering mechanism and/or other lubricated mechanical parts. In case, the e.g. hammering mechanism is activated, the calculated reference current by the regulator of the electronic control unit will be equal or higher than the specific idle run current in warm condition of the power tool, which is depending on the tool mechanics and its frictions. If the hammering mechanism due to cold conditions is not active, then the reference current would be minimum 5% lower than the measured idle run current in the warm condition.

The electronic control unit for carrying out the method according to the present invention is preferably integrated inside the housing of the power tool and electrically connected to the electric motor drive unit. The speed-control regulator is preferably provided by a proportional integral (PI) controller of the electronic control unit. The at least one temperature sensor for measuring the initial temperature Ti is preferably designed as an NTC-sensor directly arranged on the electronic control unit.

Finally, it should be noted that the method according to the present invention for implementation in the electronic speed-controlled drive described above is designed as a software program with suitable program code.

### BRIEF DESCRIPTION OF THE DRAWINGS

Further technical features improving the invention are shown in more detail below together with a description of a preferred embodiment of the invention with reference to the figures.

FIG. 1 shows a schematic side view of an electric power tool with speed-controlled drive means implemented therein,

FIG. 2 shows a block diagram of the drive means according to FIG. 1,

FIG. 3 shows a schematic flow-chart illustrating the process steps, and

FIG. 4 shows a graphical representation of the speed control during a cold start of the electric motor drive unit.

### DETAILED DESCRIPTION

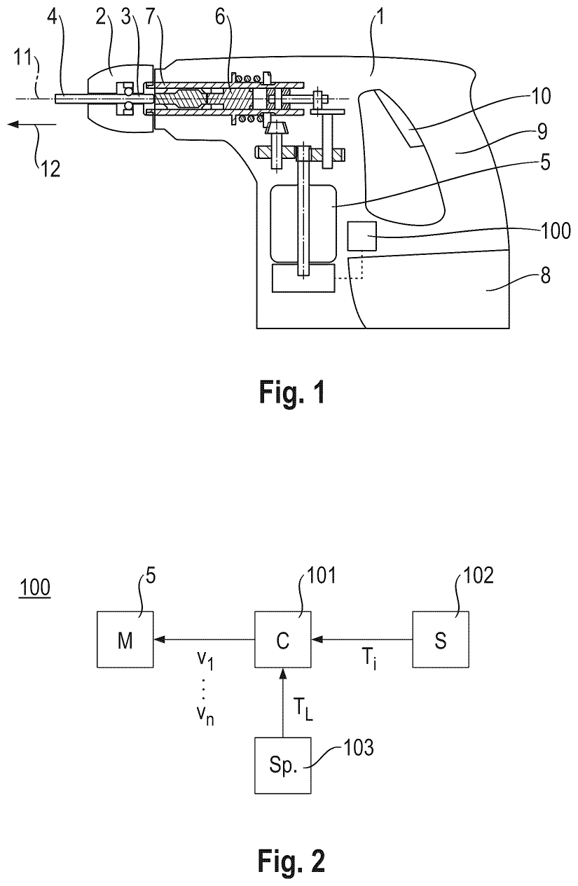

FIG. 1 illustrates a hammer drill as an exemplary embodiment of a hand-held power tool, which comprises a machine housing 1 for accommodating the drive means. The power tool further comprises a tool holder 2, into which a shaft end 3 of a tool, e.g. a drill bit 4, may be inserted. An electric motor drive unit 5, which drives a hammering mechanism 6 and an output shaft 7, forms one primary drive of the power tool. The electric motor drive unit 5 is designed as a brushless DC motor. A battery pack 8 supplies the electrical drive unit 5 with electrical current. A user may guide the power tool with the aid of a handle 9 and may start the power tool with the aid of an electrical switch 10.

During operation, the power tool rotates drill bit 4 about a working axis 11 and may thereby hammer drill bit 4 into a workpiece in direction of impact 12 along the working axis 11. For controlling the electric motor drive unit 5, the electric power tool also comprises an electronic device 100.

According to FIG. 2, the electronic device 100 comprises an electronic control unit 101 for speed control of the connected electric motor drive unit 5. A temperature sensor 102 is provided, which detects the initial temperature inside the power tool. The electric control unit 101 compares the detected initial temperature Tᵢ with a temperature limit value T_{L} stored in a connected memory unit 103 in order to provide a cold controlling of the electric motor drive unit 5 on a minimum desired speed v₁ if the initial temperature Tᵢ is below a temperature limit value T_{L}, whereas the control unit 101 provides a nominal controlling of the electric motor drive unit 5 on a tool-specific nominal desired speed vₙ, which is higher than the minimum desired speed v₁, if the initial temperature Tᵢ exceeds the temperature limit value T_{L}.

The speed-controlled drive of the electric motor drive unit 5 is provided by a proportional integral (PI) controller of the electronic control unit 101. The temperature sensor 102 for measuring the initial temperature Ti is designed as a NTC-sensor arranged adjacent to the electronic control unit 101.

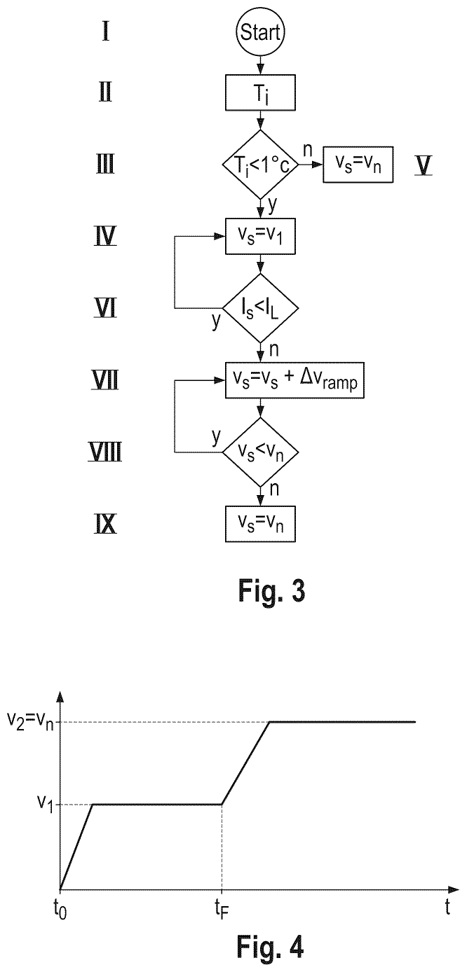

In view of FIG. 3, the method according to the present invention for a cold start drive control of a speed-controlled electric motor drive unit for driving a power tool described above comprises the following steps during at least the start phase:

After the electric motor drive unit has been switched on (I), the electric motor drive unit 5 is started up. At the same time, the initial temperature Tᵢ inside the power tool housing is detected (II) by an integrated temperature sensor. An electronic control unit compares (III) the detected initial temperature Tᵢ with a stored temperature limit value T_{L} of 1° C. for example. In case, the initial temperature Tᵢ is below the temperature limit value T_{L}, a cold controlling (IV) is carried out, in which the electric motor drive unit runs on a minimum desired speed v₁. If the measured initial temperature Tᵢ exceeds the temperature limit value T_{L} of 1° C. for example, a nominal controlling (V) is carried out, in which the electric motor drive unit runs on a higher desired speed, preferably on the nominal speed vₙ of the power tool.

Independently, the higher desired speed v₂ or vₙ will be executed if a fixed time limit T_{F} is expired according to the additional step.

The electronic control unit additionally monitors (VI) the reference current I_{S} of the electric motor drive unit 5. If the reference current I_{S} is below a low current limit value I_{L}, the desired speed will be decreased to the minimum desired speed v₁ for warming up the e.g. hammering mechanism as a lubricated component of the power tool. Otherwise, the reference speed v_{S} will be stepwise increased (VIII) by adding Δvᵣₐₘₚ increments (VII) until the nominal speed vₙ has been reached (IX).

FIG. 4 illustrates an exemplary speed control time line as described above. At a start time t₀, the initial temperature Tᵢ inside the power tool housing will be detected for comparing it with a stored temperature limit value T_{L} in this case is the actual measured temperature Tᵢ below 1° C. and in course of a cold controlling the electric motor drive unit will be operated on a minimum desired speed v₁ over a fix time limit t_{F}. After expiring the fix time limit t_{F}, a nominal controlling will be executed, in which the electric motor drive unit is operated on a higher desired speed v₂, which corresponds to the nominal speed vₙ.

If the initial temperature Tᵢ exceeds the temperature limit value T_{I} of 1° C. earlier than the fix time limit t_{F} expires, the nominal controlling will be executed on this earlier point in time.

The invention is not limited to the preferred embodiment as described above. Variations thereof are also conceivable, which are included in the scope of protection of the following claims. For example, it is also possible to refrain from the additional current monitoring functionality.

### REFERENCE SIGNS

1 machine housing
2 tool holder
3 shaft end
4 drill bit
5 electric motor drive unit
6 hammer mechanism
7 output shaft
8 battery pack
9 handle
10 electrical switch
11 working axis
12 impact
100 electronical device
101 control unit
102 comparison unit
103 memory unit
v_{N} nominal speed
v₁ minimum desired speed
v₂ higher desired speed
Δvᵣₐₘₚ speed step
Tᵢ initial temperature
T_{L} temperature limit value
I_{S} reference current
I_{H} high current limit value
I_{L} low current limit value
t₀ start time
t_{F} fix time limit
PI Proportional Integral Controller

What is claimed is:

1-12. (canceled)

13. A method for a cold start drive control of a speed-controlled electric motor drive unit for driving a power tool, the method comprising the following steps:
switching on the electric motor drive unit by manually operating an electrical switc;
detecting an initial temperature inside a power tool housing by at least one temperature sensor;
comparing the detected initial temperature with a stored temperature limit value by an electronic control unit;
cold controlling the electric motor drive unit on a minimum desired speed when the initial temperature is below the temperature limit value; and
nominal controlling the electric motor drive unit on a higher desired speed when the initial temperature exceeds the temperature limit value.

14. The method as recited in claim 13 wherein the higher desired speed is executed independently if a fixed time limit after the switching on the electric motor drive unit is expired.

15. The method as recited in claim 13 wherein the temperature limit value is set at a temperature above zero.

16. The method as recited in claim 13 wherein the temperature limit value is set to 1° C.

17. The method as recited in claim 13 wherein the minimum desired speed is set to a minimum speed where a hammer mechanism of the power tool becomes active.

18. The method as recited in claim 13 wherein the higher desired speed is higher than the minimum desired speed.

19. The method as recited in claim 13 wherein the higher desired speed is set at the nominal speed (vₙ) of the power tool.

20. The method as recited in claim 13 wherein a stepwise increasing from the minimum desired speed to at least the higher desired speed is provided.

21. The method as recited in claim 13 further comprising at least periodically monitoring a reference current of the speed-controlled electric motor drive unit calculated by the electronic control unit; and
when the reference current exceeds a low current limit value the desired speed is increased to the nominal speed, and
when the reference current is below a low current limit value the desired speed is decreased to the minimum desired speed for warming up lubricated components.

22. The method as recited in claim 13 wherein the power tool is a rotary hammer or a demolition hammer.

23. A drive arrangement for a cold start drive control of a speed-controlled electric motor drive unit for driving a power tool, the drive arrangement comprising:
an electrical switch for manually switching on the electric motor drive unit;
at least one temperature sensor provided to detect an initial temperature inside a power tool housing; and
an electronic control unit configured to compare the detected initial temperature with a stored temperature limit value; the control unit providing a cold controlling of the electric motor drive unit on a minimum desired speed when the initial temperature is below a temperature limit value, the control unit providing a nominal controlling of the electric motor drive unit on a higher desired speed when the initial temperature exceeds the temperature limit value.

24. The drive arrangement as recited in claim 23 wherein the at least one temperature sensor for measuring the initial temperature is designed as a NTC-sensor arranged on the electronic control unit.

25. The drive arrangement as recited in claim 23 wherein the speed-controlled drive of the electric motor drive unit is provided by a proportional integral controller of the electronic control unit.

26. A power tool comprising the speed-controlled drive arrangement as recited in claim 23.

27. A rotary hammer or a demolition hammer comprising the speed-controlled drive arrangement as recited in claim 23.

28. A computer program comprising commands which, when the program is executed by a computer, cause the computer to perform the steps of the method as recited in claim 13.
